(19) United States
(12) Patent Application Publication
(10) Pub. No.: US 2011/0133873 A1
(43) Pub. Date: Jun. 9, 2011

(54) Chip Type Wire Wound Choke Coil

(76) Inventor: Hsin-Chen CHEN, Taipei City (TW)

(21) Appl. No.: 12/632,034

(22) Filed: Dec. 7, 2009

(51) Int. Cl. H01F 27/29

(52) U.S. Cl. 336/192

(57) ABSTRACT

A chip type wire wound choke coil with a fixed shape and size provides different electrical characteristics by, with various standardized chip sizes, changing a diameter or a thickness of an insulation film of an insulated conductor of the choke coil, or changing a cross sectional shape of the insulated conductor of the choke coil, or changing a turn number of the choke coil with respect to turn numbers of both terminals, or changing the core material of the choke coil, or changing a height of the choke coil.

### BACKGROUND OF THE INVENTION

1. Field of the Invention

The present invention relates to a chip type wire wound choke coil, and more particularly, to a chip type wire wound choke coil with a fixed size, which can provide different electrical characteristics by changing the conditions of the coil and the core.

2. Description of the Prior Art

FIG. la and FIG. lb illustrate a front view and a side view of a conventional Dip type wire wound choke coil, which comprises a choke coil 1, a coil 11, a terminal 111 and a core 12. It is difficult to shrink the size of the conventional Dip type wire wound choke coil for not easy to manufacture and to be fit into the PCB (Print circuit Board).

FIG. 2a and FIG. 2b illustrate a front view and a side view of a SMD (Surface Mount Device) type wire wound choke coil, which comprises a choke coil 1, a coil 11, a terminal 111 and a core 12. When the SMD type wire wound choke coil is used instead of the conventional Dip type wire wound choke coil, it can achieve the object of lower cost and mass production; however, the cylindrical shape of the SMD type wire wound choke coil makes it hard for the suction nozzle of SMT Mounter to handle the choke coil and also makes it difficult for the SMT reflow oven to solder it properly.

FIG. 3a and FIG. 3b illustrate a front view and a side view of an improved SMD type wire wound choke coil, which comprises a choke coil 1, a coil 11, a terminal 111 and a core 12. In order to overcome the deficiencies in FIG. 2, a coated material 15 is disposed to make it easy to handle and to solder properly; however, using the coated material 15 could increase cost and the complexity in manufacturing the choke coil.

Therefore, the conventional Dip type or SMD type wire wound choke coil are either bulky or difficult to use or manufacture to meet the demands of miniaturization, component standardization and the trend towards higher frequencies. It is necessary to build choke coils with normalized chip sizes for the industry.

Therefore, the conventional wire wound choke coils still present some shortcomings to be overcome.

In view of the deficiencies of the prior art techniques, after years of constant researches, the inventor has successfully proposed a chip type wire wound choke coil in the present invention.

### SUMMARY OF THE INVENTION

The object of the present invention is to provide a wire wound choke coil with a normalized chip size to meet the trends of standardization, miniaturization, and high frequency use and also to provide different characteristics for users.

In order to achieve the above object, the present invention provides a chip type wire wound choke coil with a fixed shape and size to provide different electrical characteristics by, with various normalized chip sizes, changing a diameter of an insulated conductor and a thickness of an insulation film of the choke coil, or changing a cross sectional shape of the insulated conductor of the choke coil, or changing a turn number of the choke coil with respect to a turn number of both terminals, or changing the core material (such as ceramic, manganese-zinc ferrite, or nickel-zinc ferrite, etc.) of the choke coil, or changing a height of the choke coil.

### BRIEF DESCRIPTION OF THE DRAWINGS

FIG. 1a and FIG. 1b illustrate a front view and a side view of a conventional Dip type wire wound choke coil;

FIG. 2a and FIG. 2b illustrate a front view and a side view of a SMD type wire wound choke coil;

FIG. 3a and FIG. 3b illustrate a front view and a side view of an improved SMD type wire wound choke coil;

FIG. 4a, FIG. 4b, FIG. 4c, FIG. 4d, FIG. 4e, FIG. 4f, and FIG. 4g illustrate views for a chip type wire wound choke coil in the present invention;

FIG. 5a, FIG. 5b, FIG. 5c, FIG. 5d, FIG. 5e, FIG. 5f, FIG. 5g and FIG. 5h illustrate embodiment views of a chip type wire wound choke coil comprising an insulated conductor having different cross sectional shapes;

FIG. 6 illustrates an embodiment view of a chip type wire wound choke coil comprising an insulated conductor having different conductor diameters;

FIG. 7 illustrates an embodiment view of a chip type wire wound choke coil comprising an insulated conductor having different insulation film thicknesses;

FIG. 8 illustrates an embodiment view of a chip type wire wound choke coil , in which the turn number of the coil corresponds with the turn numbers of both terminals;

FIG. 9a and FIG. 9b illustrate views of a chip type wire wound choke coil having different heights;

FIG. 10a, FIG. 10b, FIG. 10c, FIG. 10d, FIG. 10e, and FIG. 10f illustrate other views of a chip type wire wound choke coil in the present invention; and

FIG. 11a, FIG. 11b, FIG. 11c, FIG. 11d, FIG. 11e, and FIG. 11f illustrate still other views of a chip type wire wound choke coil in the present invention.

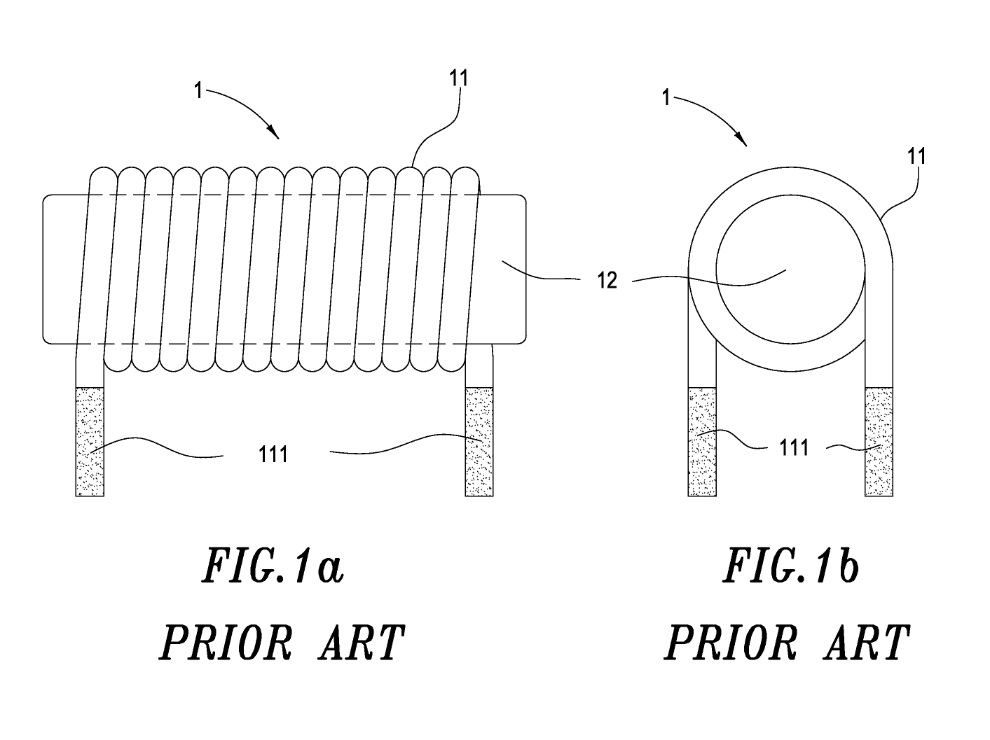

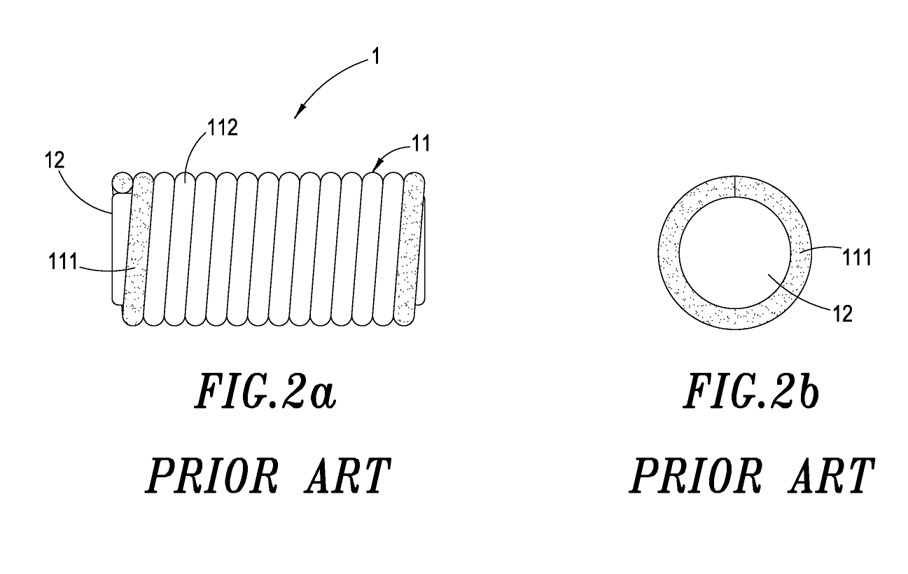

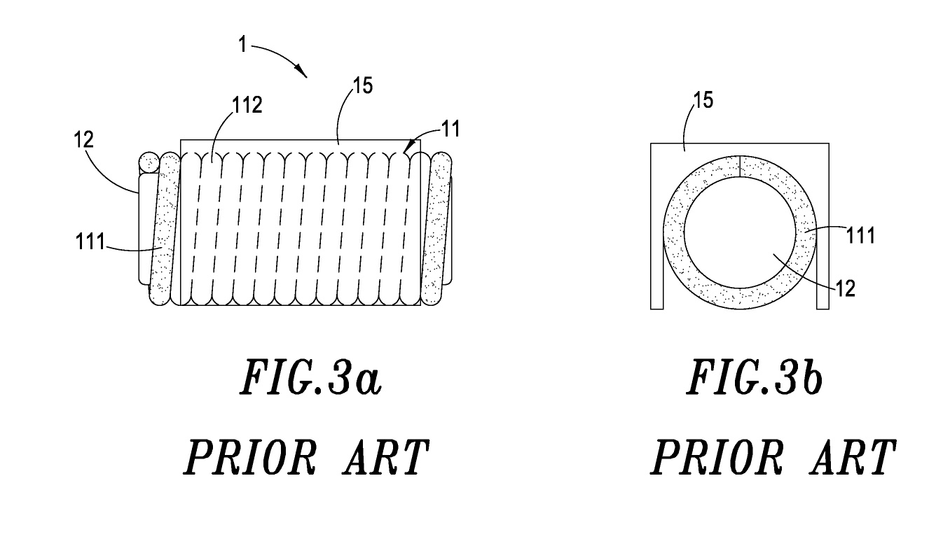

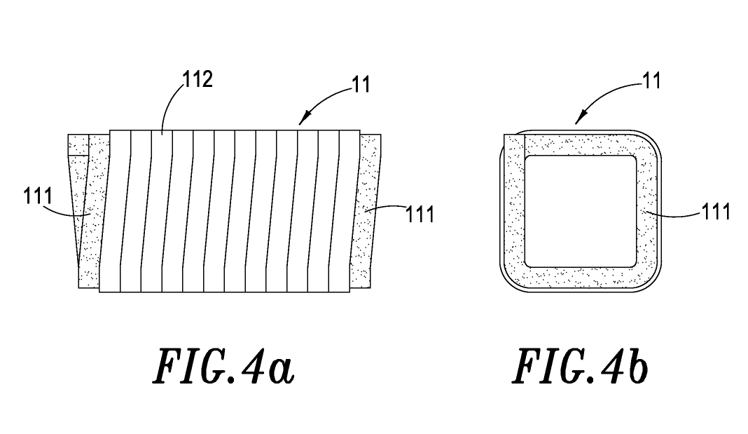

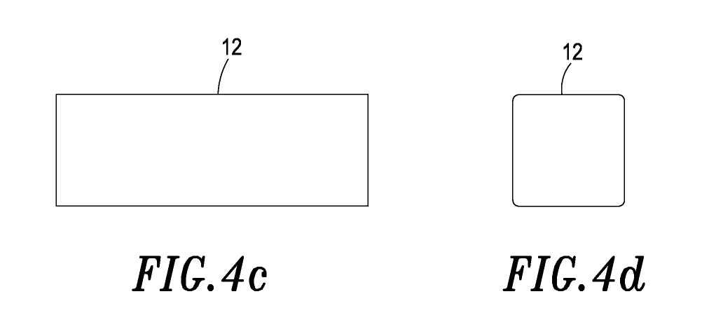

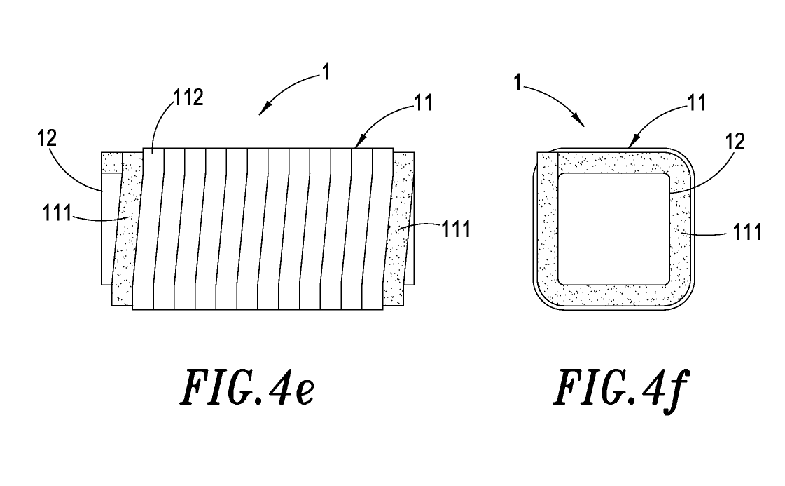

### DETAILED DESCRIPTION OF THE PREFERRED EMBODIMENT

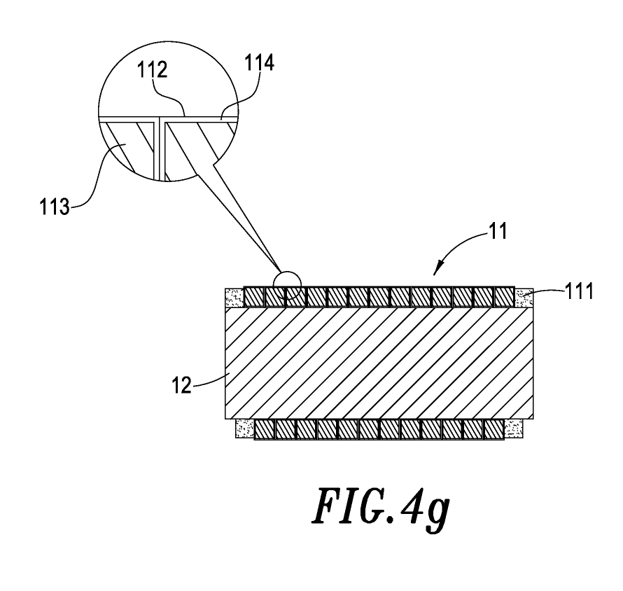

FIG. 4a, FIG. 4b, FIG. 4c, FIG. 4d, FIG. 4e, FIG. 4f, and FIG. 4g illustrate views for a chip type wire wound choke coil in the present invention. The chip type wire wound choke coil 1 is a normalized chip size passive component having a length of 1.0-5.0 mm, a width and a height of 0.5-3.5 mm, and the choke coil 1 comprises a coil 11 and a core 12.

The coil 11, as shown in FIG. 4a and FIG. 4b, is formed by winding an insulated conductor 112. The insulated conductor 112 is formed by enclosing a conductor 113 with an insulation film 114, then the insulated conductor 112 has the insulation films 114 at both ends stripped off to a predetermined length and surfaces of both ends covered with tin and wound to form the coil 11; or the insulated conductor 112 has the insulation films 114 at both ends stripped off to a predetermined length, and then the insulated conductor 112 is wound and electro-plated to form the coil 11. The conductor 113 with its insulation films 114 stripped off is covered with tin or electro-plated to form the terminals 111 at both ends of the coil 11.

T core 12 corresponds closely with the coil 11 as shown in FIG. 4c and FIG. 4d. The insulated conductor 112 has the insulation films 114 at both ends stripped off to a predetermined length and surfaces of both ends covered with tin and wound to form the coil 11, then the core 12 is inserted into the coil 11; or the insulated conductor 112 has the insulation films 114 at both ends stripped off to a predetermined length, and surfaces of both ends covered with tin, then the insulated conductor 112 is directly wound on the core 12; or the insulated conductor 112 has the insulation films 114 at both ends stripped off to a predetermined length, and then the insulated conductor 112 is wound and electro-plated to form the coil 11, then the core 12 is inserted into the coil 11; therefore the choke coil 1 is formed, as shown in FIG. 4e and FIG. 4f.

The normalized chip size choke coil can have its coil 11 or core 12 adjusted to meet different requirements when its length and width are fixed, the embodiments are described below:

The coil 11 uses the insulated conductor 112 having a diameter of 0.1-0.4 mm, the cross sectional shape can be square or circular, as shown in FIG. 4g, if the cross sectional shape is square, the area is 1×1=1, while the circular area having a diameter of 1 is 0.5×0.5×π=0.785, so the area of the square shape is 27% larger than that of the circular shape; so the rated current of the choke coil 1 increases.

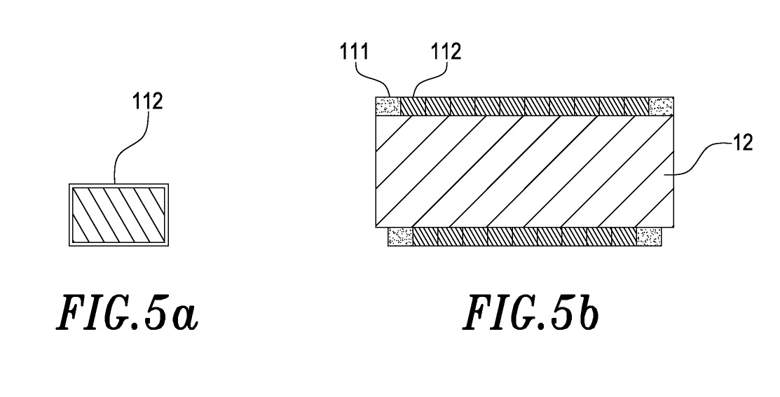

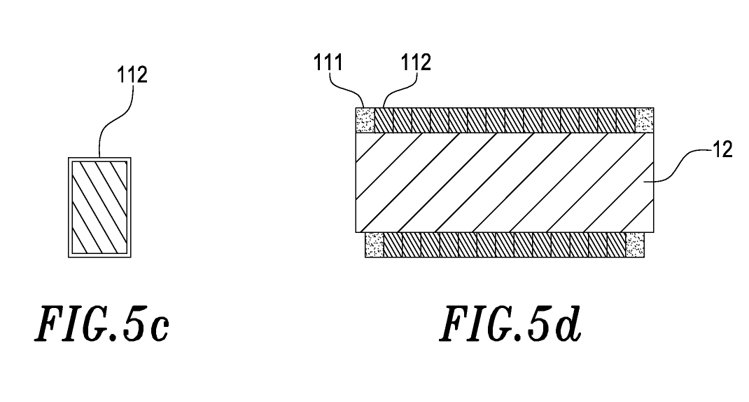

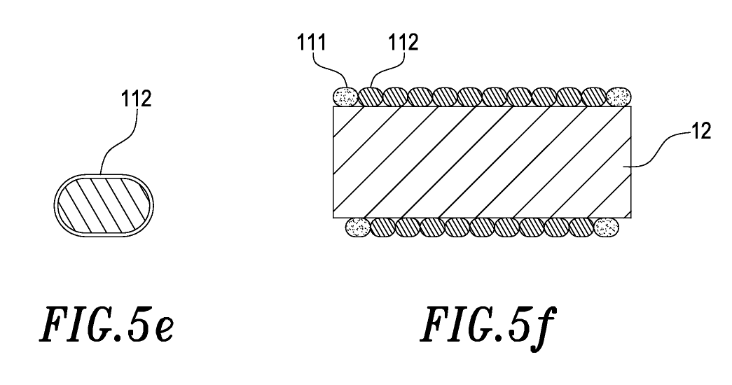

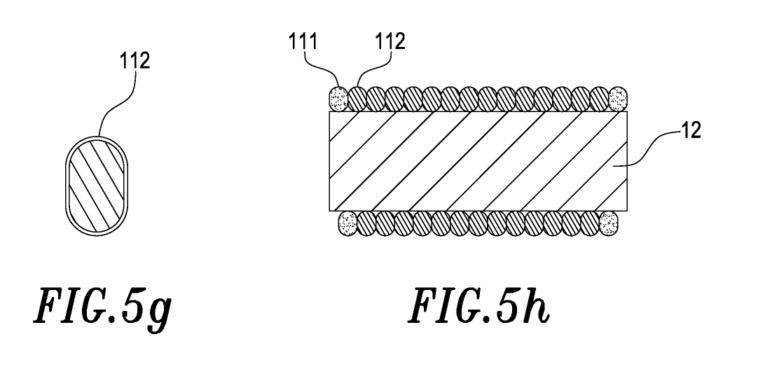

Furthermore, as shown in FIG. 5a to FIG. 5h, under the condition of a fixed size, the chip type wire wound choke coil can use different insulated conductors 112 having rectangular or elliptical cross sectional shapes, wherein the long side of the cross sectional area is 0.1-0.4 mm, the short side of the cross sectional area is any length smaller than that of the long side. Besides, under the condition that the length of the core 12 is fixed and the size of the chip type wire wound choke coil is fixed as well, when the rectangular or elliptical insulated conductor 112 is wound on the core 12 in an upright direction(as shown in FIG. 5c, FIG. 5d, FIG. 5g, and FIG. 5h, that is, the long side of the insulated conductor 112 is vertical to the core 12) or in a traverse direction(as shown in FIG. 5a, FIG. 5b, FIG. 5e, and FIG. 5f, that is, the short side is vertical to the core 12), the width and the height of the core change with respect to the width and the height of the rectangular or elliptical insulated conductor 112 (that is, when the insulated conductor 112 is wound on the core 12 in the upright direction, the width and the height of the core 12 have to decrease according to the long side of the insulated conductor 112; or when the insulated conductor 112 is wound on the core 12 in the traverse direction, the width and the height of the core 12 have to increase according to the short side of the core 12). Meanwhile, the turn number also changes to provide different electrical characteristics. Other structures in FIG. 5a to FIG. 5h are the same as those in FIG. 4g and will not be further described.

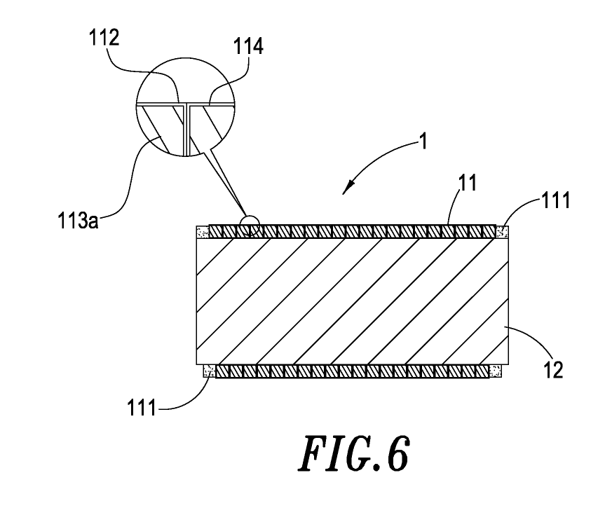

As shown in FIG. 6, under the condition of a fixed size, in order to obtain a different turn number other than that in FIG. 4g, for a fixed length of the core 12 and a fixed thickness of the insulation film 114, the diameter of the conductor 113a is reduced and the width/height of the core 12 are increased mutually to let the insulated conductor 112 be wound on the core 12 with more turns to provide different characteristics. Therefore, the present invention can provide different characteristics with different turn numbers by changing the diameter of the conductor 113a and the width/height of the core 12 (that is, when the diameter of the conductor 113a decreases, the width/height of the core 12 increases accordingly; alternatively, when the diameter of the conductor 113a increases, the width/height of the core 12 decreases accordingly). Other structures in FIG. 6 are the same as those in FIG. 4g and will not be further described.

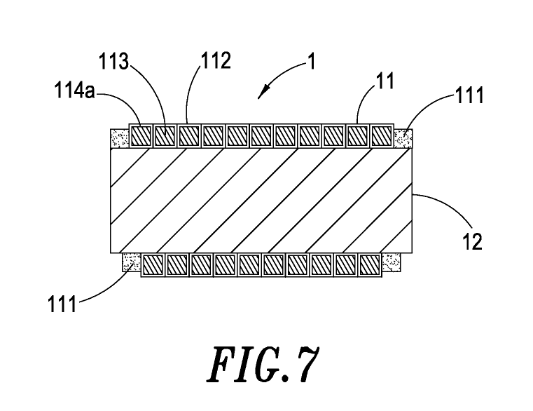

As shown in FIG. 7, under the condition of a fixed size, in order to obtain a different turn number other than that in FIG. 4g, for a fixed length of the core 12 and a fixed diameter of the conductor 113, the thickness of the insulation film 114a is increased and the width/height of the core 12 are decreased mutually to let the insulated conductor 112 be wound on the core 12 with less turns to provide different characteristics. Therefore, the present invention can provide different characteristics with different turn numbers by changing the thickness of the insulation film 114a and the width/height of the core 12 (that is, when the thickness of the insulation film 114a increases, the width/height of the core 12 decreases accordingly; alternatively, when the thickness of the insulation film 114a decreases, the width/height of the core 12 increases accordingly). Other structures in FIG. 7 are the same as those in FIG. 4g and will not be further described.

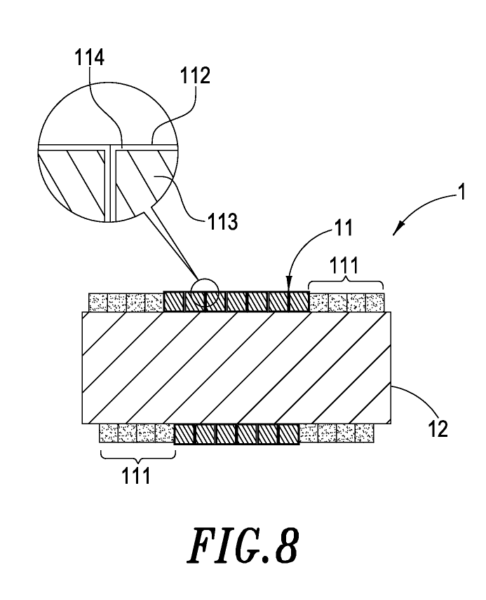

As shown in FIG. 8, under the condition of a fixed size, in order to obtain a different turn number other than that in FIG. 4g, the turn number of the coil 11 and the turn numbers of both terminals 111 of the coil 11 can be adjusted mutually (that is, when the turn number of the coil 11 increases, the turn numbers of the terminals 111 decreases; alternatively, when the turn number of the coil 11 decreases, the turn numbers of the terminals 111 increases). Other structures in FIG. 8 are the same as those in FIG. 4g and will not be further described.

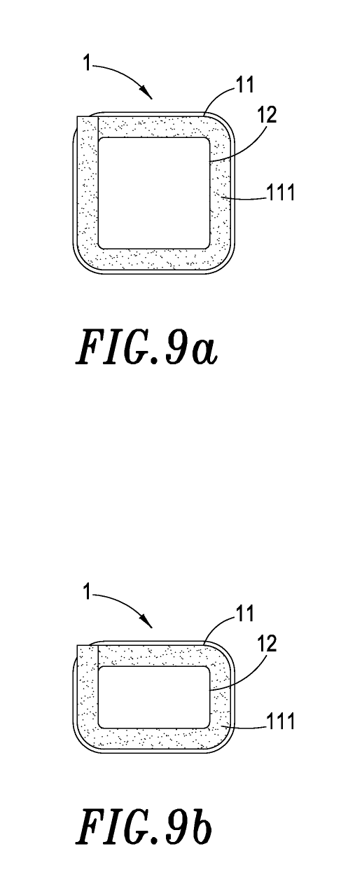

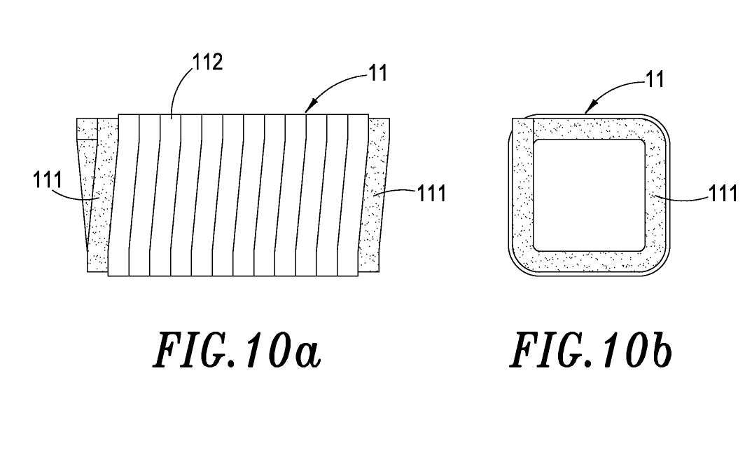

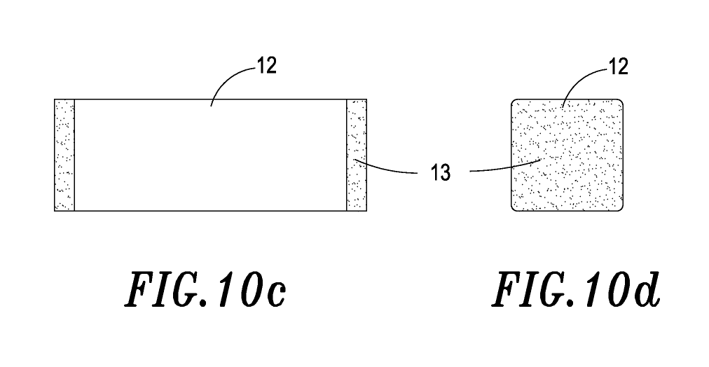

As shown in FIG. 9a and FIG. 9b, when the chip type wire wound choke coil has fixed length and width, in order to achieve the object of having different characteristics as those in FIG. 4g, the height of the choke coil 1 is adjusted to obtain different characteristics.

Besides, the core 12 of the choke coil 1 can be made of materials such as ceramic, manganese-zinc ferrite, or nickel-zinc ferrite to achieve different characteristics.

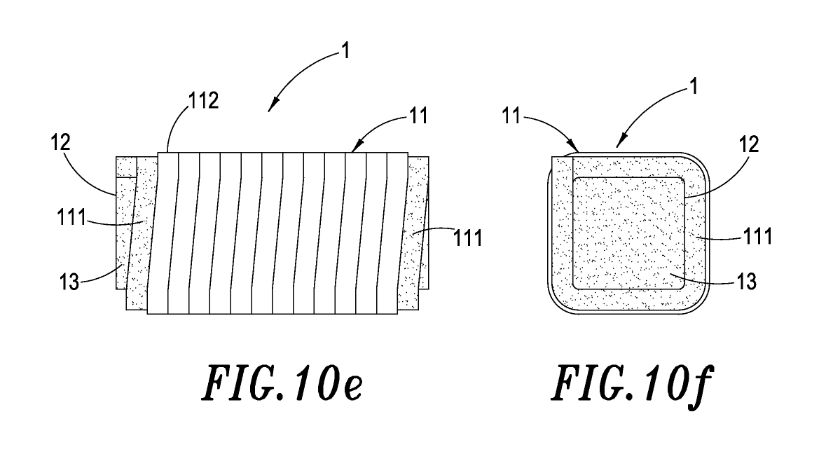

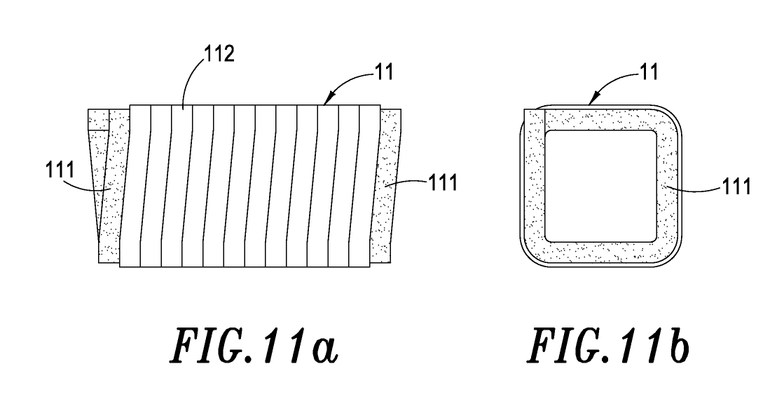

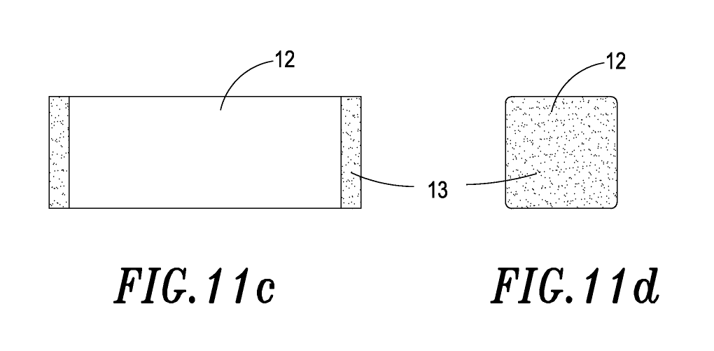

Furthermore, FIG. 10a, FIG. 10b, FIG. 10c, FIG. 10d, FIG. 10e and FIG. 10f, illustrate other views of a chip type wire wound choke coil in the present invention. The both ends of the core 12, as shown in FIG. 10c and FIG. 10d, can be electro-plated to form a metal plating layer 13; then the core 12 is enclosed with the coil 11 to improve solderability.

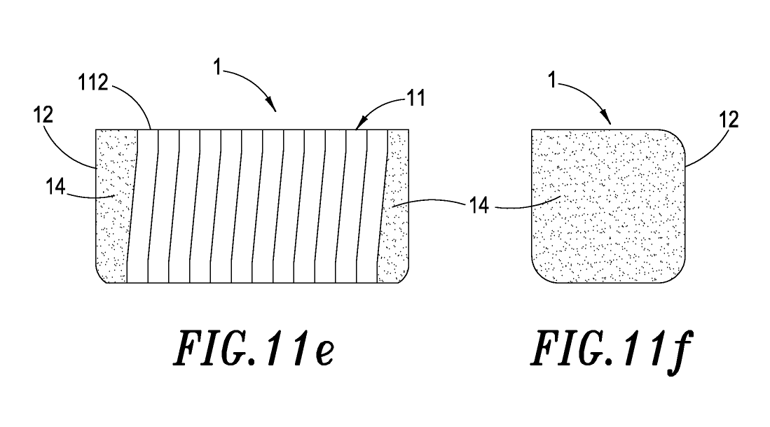

FIG. 11a, FIG. 11b, FIG. 11c, FIG. 11d, FIG. 11e and FIG. 11f, illustrate still other views of a chip type wire wound choke coil in the present invention. The both ends of the core 12, as shown in FIG. 11c and FIG. 11d, can be electro-plated to form a metal plating layer 13, when the core 12 is enclosed with the coil 11, both terminals of the choke coil 1 is covered with tin to form the choke coil 1 with the soldering layer 14 as shown in FIG. 11e and FIG. 11f to improve solderability.

Furthermore, a plurality of chip type wire wound choke coils can be connected in series or in parallel, or connected with capacitors in parallel to be soldered onto all kinds of substrates, such as a lead frame, a glass fiber substrate, a ceramic substrate, a BT resin substrate or an LTCC (Low Temperature Cofired Ceramic) to be packaged into different types of high current filter, or L type, π type or T type LC filters.

The present invention discloses a chip type wire wound choke coil, while compared to other prior art techniques, is advantageous in:

1. The present invention provides normalized chip type wire wound choke coil with different electrical characteristics.

2. The present invention can simplify the process and reduces the time for manufacturing the choke coil to achieve the objects of mass production and cost reduction.

Many changes and modifications in the above described embodiment of the invention can, of course, be carried out without departing from the scope thereof Accordingly, to promote the progress in science and the useful arts, the invention is disclosed and is intended to be limited only by the scope of the appended claims.

What is claimed is:

1. A chip type wire wound choke coil comprising:
a coil having a size of a chip component and being wound with an insulated conductor having a variable diameter, the insulated conductor having insulation films at both ends stripped off to a predetermined length and surfaces of both ends processed to form terminals for soldering; and
a core corresponding closely with the coil, the core having a fixed length, and a variable width and height corresponding with each other according to a different diameter of the insulated conductor;
wherein the choke coil uses insulated conductors having different diameters to have different turn numbers under condition of a fixed size of a normalized chip component.

2. The chip type wire wound choke coil as claimed in claim 1, wherein a cross sectional shape of the insulated conductor can be square, circular, rectangular, or elliptical.

3. The chip type wire wound choke coil as claimed in claim 1, wherein the turn number of the coil reduces as the turn numbers of both terminals increases to meet different characteristics or requirements for soldering, and vice versa.

4. The chip type wire wound choke coil as claimed in claim 1, wherein the material of the core can be ceramic, manganese-zinc ferrite, or nickel-zinc ferrite.

5. The chip type wire wound choke coil as claimed in claim 1, wherein the height of the coil changes with respect to the height of the core to provide different characteristics.

6. The chip type wire wound choke coil as claimed in claim 1, wherein both ends of the core are electro-plated to improve solderability.

7. The chip type wire wound choke coil as claimed in claim 1, wherein both terminals of the coil and both ends of the core are covered with tin to form a soldering layer to improve solderability.

8. A chip type wire wound choke coil comprising:
a coil having a size of a chip component and being wound with an insulated conductor having a insulation film of a variable thickness, the insulated conductor having insulation films at both ends stripped off to a predetermined length and surfaces of both ends processed to form terminals for soldering; and
a core corresponding closely with the coil, the core having a fixed length, and a variable width and height corresponding with each other according to a different insulation film thickness of the insulated conductor;
wherein the choke coil uses insulated conductors having different thickness of insulation film to have different turn numbers under the condition of a fixed size of a normalized chip component.

9. The chip type wire wound choke coil as claimed in claim 8, wherein a cross sectional shape of the insulated conductor can be square, circular, rectangular, or elliptical.

10. The chip type wire wound choke coil as claimed in claim 8, wherein the turn number of the coil reduces as the turn numbers of both terminals increases to meet different characteristics or requirements for soldering, and vice versa.

11. The chip type wire wound choke coil as claimed in claim 8, wherein the material of the core can be ceramic, manganese-zinc ferrite, or nickel-zinc ferrite.

12. The chip type wire wound choke coil as claimed in claim 8, wherein the height of the coil changes with respect to the height of the core to provide different characteristics.

13. The chip type wire wound choke coil as claimed in claim 8, wherein both ends of the core are electro-plated to improve solderability.

14. Thee chip type wire wound choke coil as claimed in claim 8, wherein both terminals of the coil and both ends of the core are covered with tin to form a soldering layer to improve solderability.
